(19) United States
(12) Patent Application Publication
(10) Pub. No.: US 2012/0320434 A1
(43) Pub. Date: Dec. 20, 2012

(54) OVERHEAD IMAGE-READING APPARATUS, IMAGE PROCESSING METHOD, AND COMPUTER PROGRAM PRODUCT

(75) Inventor: Yoshifumi TAKEDA, Ishikawa (JP)

(73) Assignee: PFU LIMITED

(21) Appl. No.: 13/445,436

(22) Filed: Apr. 12, 2012

(30) Foreign Application Priority Data
Jun. 16, 2011 (JP) 2011-133875

(51) Int. Cl. H04N 1/04

(52) U.S. Cl. 358/475

(57) ABSTRACT

An overhead image-reading apparatus includes an imaging unit integrally formed with a light source, and a light amount adjusting unit that adjusts a light amount so as to keep luminance of a surface of a medium to be read constant based on a correction value of the light amount corresponding to an object-image distance.

### CROSS-REFERENCE TO RELATED APPLICATION

This application is based upon and claims the benefit of priority from Japanese Patent Application No. 2011-133875, filed Jun. 16, 2011, the entire contents of which are incorporated herein by reference.

### BACKGROUND OF THE INVENTION

1. Field of the Invention

The present invention relates to an overhead image-reading apparatus, an image processing method, and a computer program product.

2. Description of the Related Art

Some conventional overhead image-reading apparatuses can adjust luminance when reading documents.

For example, JP-A-2001-28671 discloses an image-reading apparatus that controls a light beam so as to correspond to a scanning position by using a mirror and adjusts luminance based on detection information of a reflection light amount on a luminance detection area provided on a document placement unit. As a result, the image-reading apparatus ensures sufficient luminance without dazzling a user of the apparatus.

The conventional overhead image-reading apparatuses, such as the apparatus disclosed in JP-A-2001-28671, however, require dedicated hardware (the mirror and the luminance detection area) and also has a problem in that a light amount on a surface of a document changes with a change in an object-image distance, so that contrast in a read image varies.

### SUMMARY OF THE INVENTION

It is an object of the present invention to at least partially solve the problems in the conventional technology.

An overhead image-reading apparatus according to one aspect of the present invention includes an imaging unit integrally formed with a light source, and a light amount adjusting unit that adjusts a light amount so as to keep luminance of a surface of a medium to be read constant based on a correction value of the light amount corresponding to an object-image distance.

An image processing method according to another aspect of the present invention is executed by an overhead image-reading apparatus including an imaging unit integrally formed with a light source, and the method executed by the overhead image-reading apparatus includes a light amount adjusting step of adjusting a light amount so as to keep luminance of a surface of a medium to be read constant based on a correction value of the light amount corresponding to an object-image distance.

A computer program product having a non-transitory computer readable medium according to still another aspect of the present invention includes programmed instructions for an image processing method executed by an overhead image-reading apparatus including an imaging unit integrally formed with a light source, wherein the instructions, when executed by the overhead image-reading apparatus, cause the overhead image-reading apparatus to execute a light amount adjusting step of adjusting a light amount so as to keep luminance of a surface of a medium to be read constant based on a correction value of the light amount corresponding to an object-image distance.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of the overhead image-reading apparatus according to the embodiment;

FIG. 2 is a perspective view of the overhead image-reading apparatus according to the embodiment;

FIG. 3 is a block diagram of an example of a structure of a control unit in the embodiment;

FIG. 4 is a flowchart of an example of a processing executed by the overhead image-reading apparatus in the embodiment;

FIG. 5 is a flowchart of an example of a processing executed by the overhead image-reading apparatus in the embodiment;

FIG. 6 is a diagram of an example of the table that represents the reading target lines and the values of luminance for the reading target lines so as to correspond to each other;

FIG. 7 is a diagram of an example of the relationship between the object-image distance and luminance in the embodiment;

FIG. 8 is a diagram of an example of the relationship between the object-image distance and luminance in the embodiment;

FIG. 9 is a flowchart of an example of a processing executed by the overhead image-reading apparatus in the embodiment;

FIG. 10 is a diagram of an example of the table that represents the reading target lines and the values of exposed time for the reading target lines so as to correspond to each other.

### DETAILED DESCRIPTION OF THE PREFERRED EMBODIMENT

Embodiments of an overhead image-reading apparatus, an image processing method, and a computer program product according to the present invention will be explained in detail below based on the drawings. The embodiments do not limit the invention.

Structure of an Overhead Image-Reading Apparatus 1

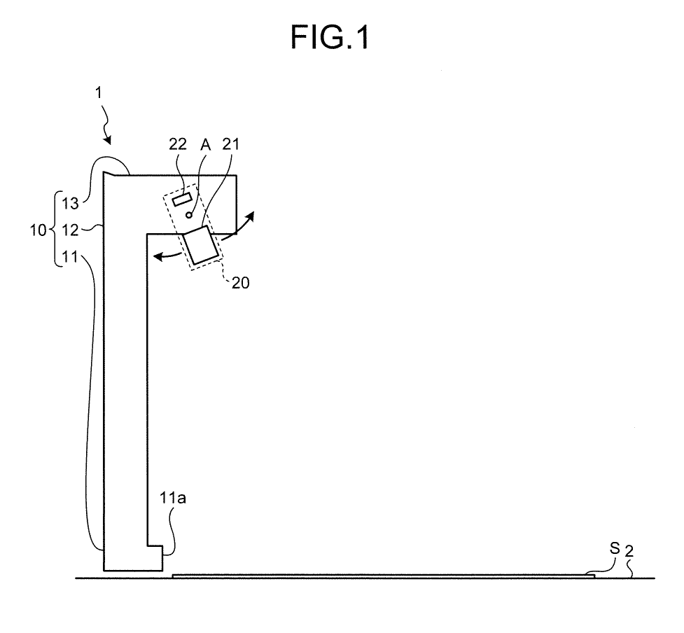

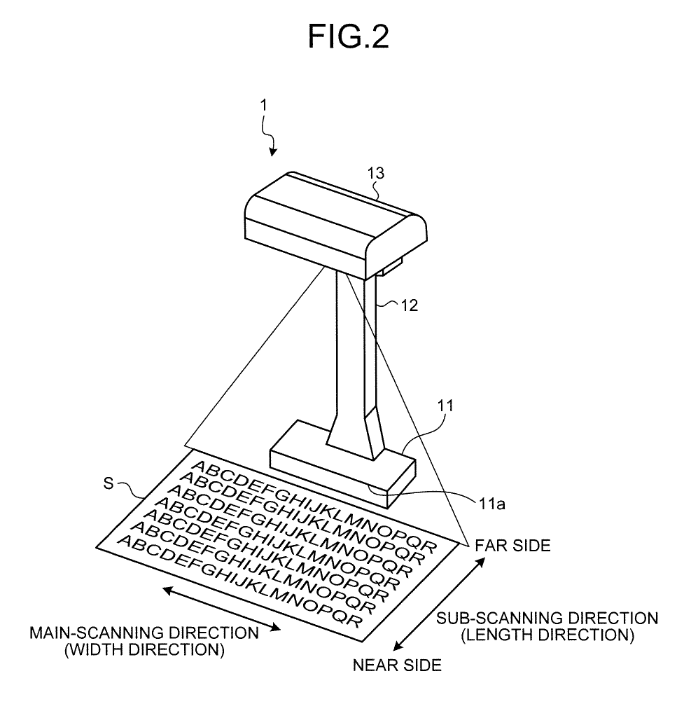

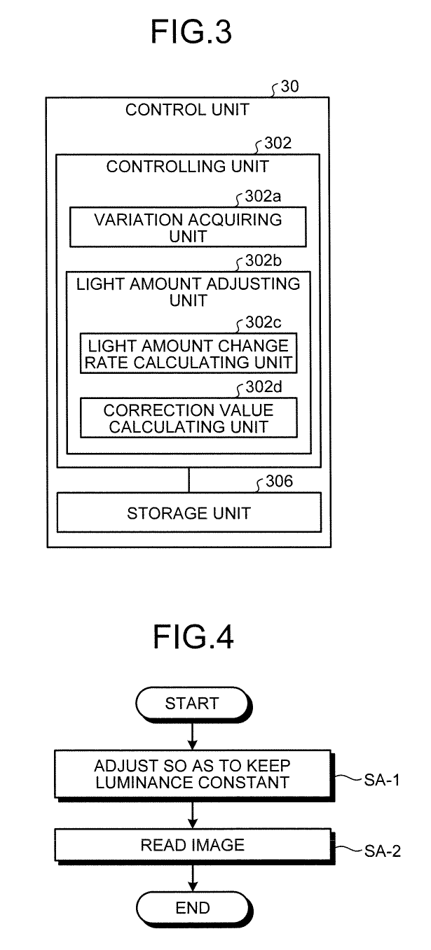

A structure of an overhead image-reading apparatus 1 is explained below with reference to FIGS. 1 to 3. FIG. 1 is a diagram of the overhead image-reading apparatus 1 and depicts a cross section perpendicular to a rotation axis A of the overhead image-reading apparatus 1 according to the embodiment. FIG. 2 is a perspective view of the overhead image-reading apparatus 1 according to the embodiment. FIG. 3 is a block diagram of an example of a structure of a control unit 30 in the embodiment and conceptually depicts only a part relating to the invention in the structure.

The overhead image-reading apparatus 1 shown in FIGS. 1 and 2 is an overhead scanner including an imaging unit 22 such as a reading sensor (an image sensor) that receives direct light which does not reflects off a mirror and that is integrally formed with a light source 21. The overhead image-reading apparatus 1 includes a main body 10, an optical unit 20, and the control unit 30. The control unit 30 may be included inside the main body 10 or inside the optical unit 20, or may be provided at an outside of the overhead image-reading apparatus 1. The overhead image-reading apparatus 1 can read an image of the medium S to be read placed on a placement surface 2 located under the optical unit 20, i.e., a lower side in the vertical direction. The placement surface 2 is, for example, a flat surface such as a top surface of a desk. In the embodiment, the overhead image-reading apparatus 1 is placed on the same plane as the placement surface 2, as an example. The overhead image-reading apparatus 1, however, is not limited to be placed in this manner. The place on which the overhead image-reading apparatus 1 is placed may differ from the placement surface 2 on which the medium S to be read is placed. For example, the overhead image-reading apparatus 1 may be provided with a placement table having the placement surface 2.

The main body 10 includes a pedestal 11, a supporter 12, and a cover 13. The pedestal 11 is placed on the placement surface 2, for example, and supports the whole of the main body 10 as a base of the main body 10. Operation members of the overhead image-reading apparatus 1 such as a power source switch and an image-reading start switch are arranged on the pedestal 11, for example. The pedestal 11 has a flat shape, for example, and is placed such that a bottom surface thereof and the placement surface 2 are faced to each other. The pedestal 11 of the embodiment has a flat rectangular parallelepiped shape, or a similar or resembling shape thereof. The length in the vertical direction is smaller than both of the length in a width direction (a main-scanning direction, which is described later) and the length in a length direction (a sub-scanning direction, which is described later). The pedestal 11 may be shaped such that the length in the width direction is larger than the length in the length direction.

The medium S to be read is a reading target and is placed such that a side thereof abuts on a front surface 11a that is one of four side surfaces of the pedestal 11. That is, the medium S to be read is placed on the placement surface 2 such that the side thereof is parallel to the front surface 11a. In the embodiment, when the medium S to be read having a rectangular shape is placed such that a side thereof abuts on the front surface 11a, a direction parallel to the side abutting on the front surface 11a of the medium S is described as the “width direction”. A direction parallel to a side perpendicular to the side abutting on the front surface 11a of the medium S to be read is described as the “length direction”. That is, in the length direction, a user and the overhead image-reading apparatus 1 are faced to each other when the user faces the overhead image-reading apparatus 1 with the medium S to be read interposed therebetween. When the user faces the overhead image-reading apparatus 1 with the medium S to be read interposed therebetween in the length direction, a side near the user is described as a “near side” while a side remote from the user is described as a “far side”.

The supporter 12 is connected to the pedestal 11 and extends upward in the vertical direction from the pedestal 11. The supporter 12 is formed in a columnar shape or a chimney-like shape having a rectangular cross section, for example. The lower portion of the supporter 12 is formed in a tapered shape such that more increases a cross-section thereof the more downward in the vertical direction it extends. The supporter 12 is connected to a side of an upper surface of the pedestal 11. Specifically, the supporter 12 is connected to a side of the upper surface of the pedestal 11 and the side is opposite the side on which the placed medium S to be read abuts, out of four sides forming the edge of the upper surface. In other words, the supporter 12 is connected to an end, which is remote from the medium S to be read, i.e., on the far side, of the pedestal 11. The supporter 12 is connected to the pedestal 11 at a central portion of the pedestal 11 in the width direction.

The cover 13 supports the optical unit 20 rotatably, and can house the optical unit 20 inside thereof. The cover 13 covers the optical unit 20 from the upper side in the vertical direction. The cover 13 has a concave portion formed on an under surface thereof, for example, and can house the optical unit 20 inside the concave portion. The cover 13 is connected to an upper end of the supporter 12 in the vertical direction. The cover 13 protrudes from the supporter 12 on the near side in the length direction and on both sides in the width direction. Specifically, the cover 13 protrudes from the supporter 12 to a side on which the medium S to be read is placed and to both sides in the width direction.

In the overhead image-reading apparatus 1, the pedestal 11 and the cover 13 are faced to each other in the vertical direction, and connected with the supporter 12 at both ends located on a side opposite the medium S side in the length direction. The cover 13 protrudes on the near side in the length direction beyond the pedestal 11. That is, at least a part of the cover 13 and the medium S to be read are faced to each other in the vertical direction when the medium S is placed on the placement surface 2 so as to abut on the pedestal 11.

The optical unit 20 can rotate around the rotation axis A with respect to the main body 10. The rotation axis A extends in the width direction. That is, the rotation axis A is parallel to the front surface 11a. The optical unit 20 is supported by the cover 13 rotatably around the rotation axis A. A driving unit (not shown) is disposed in an inside of the cover 13. The driving unit rotates the optical unit 20 around the rotation axis A. The driving unit includes an electric motor, and a gear unit that connects a rotation axis of the motor and the optical unit 20, for example. The motor is a stepping motor, for example, and can control a rotational angle of the optical unit 20 with high accuracy. The gear unit, which includes a combination of plural gears, for example, reduces the rotation of the motor and transmits the reduced rotation to the optical unit 20.

The optical unit 20 includes the light source 21 and the imaging unit 22. The angle made between the optical axis of the light source 21 and the medium S to be read changes during reading of the medium S. The light source 21, which is a reading light source, includes a light emitting unit such as a light-emitting diode (LED) and can irradiate the medium S to be read with light from the upper side in the vertical direction. The light source 21 may be formed with a plurality of LEDs arranged in a straight line along the main-scanning direction, for example. The light source 21 irradiates an image on a reading target line of the medium S to be read, i.e., a read image, with light. For example, the imaging unit 22 is an image sensor including a charge coupled device (CCD) and can image the medium S to be read that is placed on the placement surface 2. Specifically, the imaging unit 22 converts light that is reflected by a read image on the reading target line and incident on the imaging unit 22 into electronic data by photoelectric conversion and produces image data of the read image.

The light source 21 is disposed outside the imaging unit 22 in a radial direction perpendicular to the rotation axis A. A direction of an optical axis of the light source 21 is perpendicular to the rotation axis A. The optical axis of the imaging unit 22 and the optical axis of the light source 21 coincide with each other when viewed in an axial direction of the rotation axis A. That is, light in a direction perpendicular to the rotation axis A when viewed in the axial direction of the rotation axis A is incident on the imaging unit 22 and the incident light is imaged by a lens on a light receiving surface of the imaging unit 22.

The imaging unit 22 is a line sensor including a plurality of pixels that read an image and are arranged in the main-scanning direction. The imaging unit 22 is disposed in the optical unit 20 such that the main-scanning direction is parallel to the rotation axis A. Each pixel receives light of the read image imaged by the lens on the light receiving surface and outputs an electrical signal corresponding to the received light. The imaging unit 22 can read an image on the reading target line of the medium S to be read and produce line image data in the main-scanning direction. The imaging unit 22 may be a single-line sensor or a multiple-line sensor.

The overhead image-reading apparatus 1 can acquire an image on the reading target line at any position in the sub-scanning direction on the medium S to be read by adjusting a rotational position of the optical unit 20 around the rotation axis A. The overhead image-reading apparatus 1 can acquire image data of the whole of the medium S to be read by repeating the acquisition of the line image data and positional adjustment of the reading target line by rotating the optical unit 20. That is, in the overhead image-reading apparatus 1, the document surface is scanned with irradiation light of the light source 21 in the sub-scanning direction and the imaging unit 22 reads an image of the reading target line irradiated with light, resulting in the image of the medium S to be read being produced. For example, the overhead image-reading apparatus 1 produces two-dimensional image data of the medium S to be read by reading a line image of each reading target line while the position of the reading target line is sequentially shifted from the far side to the near side in the length direction.

In the optical unit 20 of the overhead image-reading apparatus 1 of the embodiment, the optical axis of the light source 21 and the optical axis of the imaging unit 22 are along the same axis in directional vision of the rotation axis A. The light source 21 and the imaging unit 22 are fixed at the respective positions in the optical unit 20 and rotated around the rotation axis A with the rotation of the optical unit 20 without changing a mutual positional relationship. Unlike in the case that the light source 21 and the imaging unit 22 are independently driven and controlled from each other and that the light source 21 and a reflective member guiding light to the imaging unit 22 are independently driven and controlled from each other, the difference is suppressed from being produced between irradiation light of the light source 21 and the imaging target position of the imaging unit 22. Therefore, the light source 21 can irradiate the reading target line serving as the imaging target of the imaging unit 22 with high positional accuracy. As an example, the center of the reading target line in the sub-scanning direction can coincide with the center of the irradiation width of light emitted from the light source 21 regardless of the rotational position of the optical unit 20. As a result, the overhead image-reading apparatus 1 of the embodiment suppresses the occurrence of light amount unevenness and the like, and improves quality of produced images.

In addition, because the difference is suppressed from being produced between irradiation light of the light source 21 and the imaging target position of the imaging unit 22, the irradiation width in the sub-scanning direction of the light source 21 can be reduced and light amount can be intensively supplied on the reading target line. As a result, the overhead image-reading apparatus 1 of the embodiment can read the medium S to be read with high resolution, and high speed.

The control unit 30 generally includes a controlling unit 302, and a storage unit 306. The controlling unit 302 is a Central Processing Unit (CPU) or the like that performs overall control on the whole overhead image-reading apparatus 1. The storage unit 306 is a device for storing various databases, tables, or the like. Each unit of the overhead image-reading apparatus 1 is communicably connected to one another via any communication channels. The optical unit 20 may connect to the controlling unit 302 and the like via an input-output control interface unit. Furthermore, the overhead image-reading apparatus 1 may be communicably connected to a network via a communication device, such as a router, and a wired communication line or a wireless communication means such as a dedicated line.

The storage unit 306 is a storage unit that is a fixed disk device such as Hard Disk Drive (HDD), Solid State Drive (SSD) and the like, and stores various databases and tables. For example, the storage unit 306 stores therein various programs, tables, files, databases, web pages, and the like used in various processing. The storage unit 306 may store produced image data. The storage unit 306 may store specification information of the overhead image-reading apparatus 1, such as a distance between the rotation axis A and an image plane (e.g., a sensor surface) of the imaging unit 22, and the distance between the imaging unit 22 and the light source 21.

the controlling unit 302 includes an internal memory for storing a control program such as an Operating System (OS), programs that define various processing procedures, and necessary data. The controlling unit 302 performs information processing for executing various processing by these programs or the like. The controlling unit 302 functionally and conceptually includes a variation acquiring unit 302a, a light amount adjusting unit 302b, and a light amount change rate calculating unit 302c.

The variation acquiring unit 302a is a variation acquiring unit including a height detecting unit that acquires (detects) values including variations of a height, a distance, and an angle. The variation acquiring unit 302a may calculate a height h of the rotational center. The height h is the distance between the rotation axis A and the placement surface 2 or the medium S to be read. The variation acquiring unit 302a may acquire a reading range X in the main-scanning direction, a main-scanning position x that is the reading position in the main-scanning direction, a reading range Y in the sub-scanning direction, and a sub-scanning position y that is the reading position in the sub-scanning direction on the medium S to be read. The variation acquiring unit 302a may calculate an object-image distance L that is an optical path length of each line, i.e., the distance between the imaging unit 22 and the medium S to be read. The variation acquiring unit 302a may calculate the object-image distance L based on the sub-scanning position y, the height h of the rotation center that is the distance between the rotation axis A and the medium S to be read, and a distance between the rotation axis A and an image plane of the imaging unit 22. The variation acquiring unit 302a may acquire read resolution R of the imaging unit 22. The variation acquiring unit 302a may calculate the number of reading target lines α based on the calculated reading range Y in the sub-scanning direction. The variation acquiring unit 302a may calculate the number of reading target lines α based on the reading range Y and the read resolution R.

The light amount adjusting unit 302b is a light amount adjusting unit that adjusts a light amount so as to keep luminance of a surface of the medium S to be read constant based on a correction value of the light amount corresponding to the object-image distance L. The light amount adjusting unit 302b adjusts the light amount so as to keep the luminance of the surface of the medium S to be read constant by controlling luminance of the light source 21. The light amount adjusting unit 302b adjusts the light amount so as to keep the luminance of the surface of the medium S to be read constant by controlling exposed time of the imaging unit 22. The light amount adjusting unit 302b may adjust a light amount so as to keep the luminance on the surface of the medium S to be read constant based on a variation of the height acquired by the variation acquiring unit 302a.

As illustrated in FIG. 3, the light amount adjusting unit 302b includes the light amount change rate calculating unit 302c, and a correction value calculating unit 302d. The light amount change rate calculating unit 302c is a light amount change rate calculating unit that calculates a light amount change rate for each line with the object-image distance L. The correction value calculating unit 302d is a correction value calculating unit that calculates the correction value of the light amount based on the light amount change rate. The correction value may be a parameter correction value.

Processing Executed by the Overhead Image-Reading Apparatus 1

An example of the processing executed by the overhead image-reading apparatus 1 of the embodiment is explained below with reference to FIGS. 4 to 10.

### Outline of the Embodiment of the Present Invention

The outline of an embodiment of the present invention is explained below with reference to FIG. 4. FIG. 4 is a flowchart of an example of the processing executed by the overhead image-reading apparatus 1 in the embodiment.

The embodiment has the following basic features in general. As illustrated in FIG. 4, the light amount adjusting unit 302b adjusts a light amount so as to keep the luminance on the surface of the medium S to be read constant based on the correction value of a light amount corresponding to the object-image distance L (step SA-1). That is, the light amount adjusting unit 302b uses light amount correction value information of each object-image distance and changes a light amount corresponding to the information.

The controlling unit 302 allows the imaging unit 22 to read an image on the reading target line of the medium S to be read (step SA-2), and then ends the processing.

Image Reading Processing

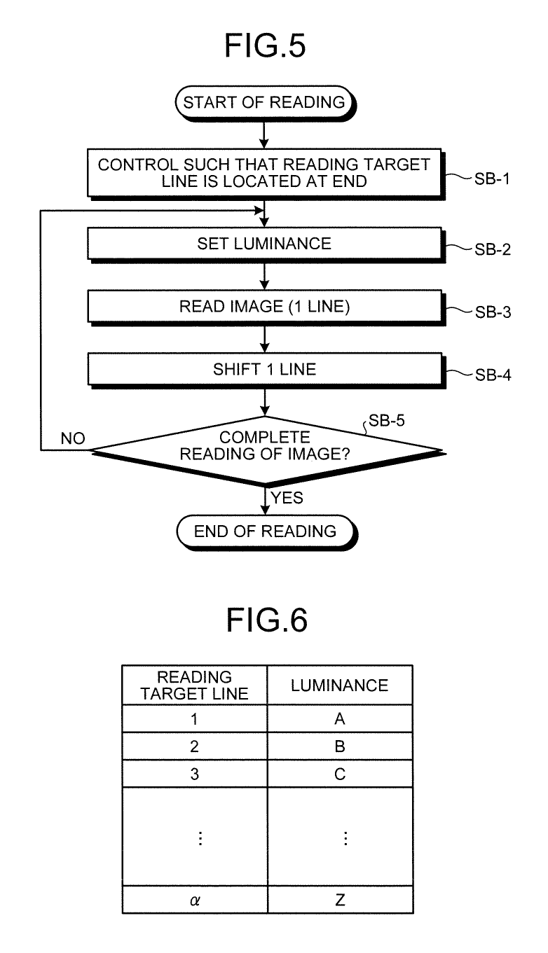

An example of the image reading processing of the embodiment is explained below with reference to FIGS. 5 to 10.

Image Reading Processing (1)

An example of the image reading processing of the embodiment is explained below with reference to FIGS. 5 to 8. FIG. 5 is a flowchart of an example of the processing executed by the overhead image-reading apparatus 1 in the embodiment.

As illustrated in FIG. 5, the controlling unit 302 controls the optical unit 20 such that the reading target line, which is the imaging target of the imaging unit 22, is located at the end of the medium S to be read (step SB-1).

The light amount change rate calculating unit 302c calculates a light amount change rate for each reading target line with the object-image distance L. The correction value calculating unit 302d calculates a parameter correction value of a light amount based on the light amount change rate calculated by the light amount change rate calculating unit 302c. The light amount adjusting unit 302b prepares correction information based on the parameter correction value calculated by the correction value calculating unit 302d, sets a value of the luminance of the light source 21 for each line based on the correction information, and controls and adjusts the luminance of the light source 21 so as to keep the luminance of the surface of the medium S to be read constant (step SB-2). The light amount adjusting unit 302b may adjust a light amount so as to keep the luminance on the surface of the medium S to be read constant based on a variation of the height acquired by the variation acquiring unit 302a. That is, the light amount adjusting unit 302b may adjust a light amount in a reading direction so as to keep the luminance on the surface of the medium S to be read constant when the luminance of the surface of the medium S is changed due the change in the height. The light amount adjusting unit 302b may calculate the values of luminance corresponding to each reading target line before the imaging unit 22 reads images and prepare a table that represents the reading target lines and the values of luminance for the reading target lines so as to correspond to each other. The parameter correction value may be calculated by the following formula.

Parameter correction value=(Light amount change rate of a certain line position/Light amount change rate of the farthest line)×Correction step

The correction step may be a sample hold (SH) period.

The correction information may be calculated by the following formula.

Correction information=Parameter correction value of a certain line position/Parameter correction value of the farthest line

An example of the table that represents the reading target lines and the values of luminance for the reading target lines so as to correspond to each other in the embodiment is explained below with reference to FIG. 6. FIG. 6 is a diagram of an example of the table that represents the reading target lines and the values of luminance for the reading target lines so as to correspond to each other in the embodiment.

As illustrated in FIG. 6, in the table that represents the reading target lines and the values of luminance for the reading target lines so as to correspond to each other, the reading target lines (1, 2, 3, . . . , and α) based on the number of reading target lines a of the medium S to be read by the imaging unit 22 and the values of luminance (A, B, C, . . . , and Z) are stored so as to correspond to each other. The number of reading target lines α is calculated by the variation acquiring unit 302a based on the reading range Y in the sub-scanning direction of the medium S to be read and the read resolution R of the imaging unit 22. Preparation of such a table in advance enables light amount change rate calculation and image reading to be separately performed and processing to be performed at high speed when reading of the medium S to be read of the same type is repeated, for example.

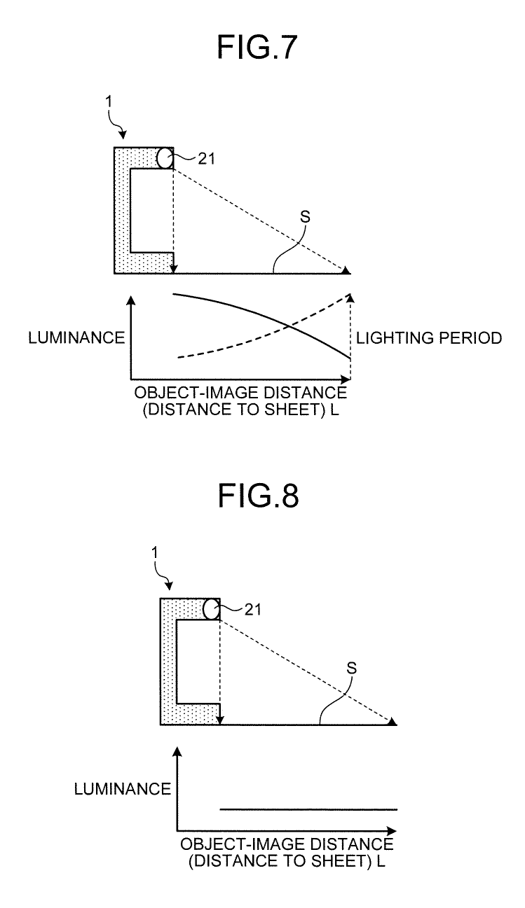

An example of luminance setting processing in the embodiment is explained with reference to FIGS. 7 and 8. FIGS. 7 and 8 are diagrams of an example of the relationship between the object-image distance L and luminance in the embodiment.

As illustrated with the solid line in the graph of FIG. 7, when the light source (lighting) 21 irradiates the medium S to be read with light with certain luminance, the luminance on the surface of the medium S decreases as the object-image distance (distance to a sheet) L increases. When a lighting period of the lighting 21 is changed as illustrated with the dashed line in the graph of FIG. 7 (e.g., so as to increase in inverse proportion to the value of luminance on the surface of the medium S to be read), the luminance of the surface of the medium S is constant regardless of the object-image distance L as illustrated with the solid line in the graph of FIG. 8.

Referring back to FIG. 5, the controlling unit 302 allows the imaging unit 22 to read an image on the reading target line of the medium S to be read based on the adjustment done by the light amount adjusting unit 302b (step SB-3).

The controlling unit 302 controls the optical unit 20 such that the reading target line of the medium S to be read is shifted to the next target line (step SB-4).

The controlling unit 302 determines whether the imaging unit 22 completes the reading of the images on all of the α reading target lines based on the number of reading target lines α of the medium S to be read calculated by the variation acquiring unit 302a (step SB-5).

When it is determined that the reading of the images is incomplete at step SB-5 (NO at step SB-5), the controlling unit 302 proceeds to step SB-2. When it is determined that the reading of the images is complete at step SB-5 (YES at step SB-5), the controlling unit 302 ends the processing.

Image Reading Processing (2)

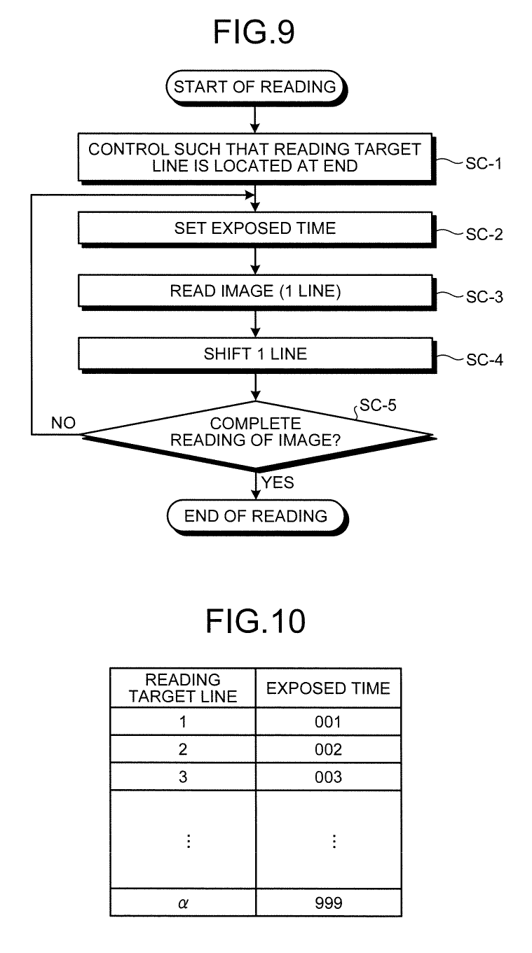

An example of the image reading processing of the embodiment is explained below with reference to FIG. 9. FIG. 9 is a flowchart of an example of the processing executed by the overhead image-reading apparatus 1 in the embodiment.

The processing of step SC-1 in the image reading processing (2) shown in FIG. 9 is the same as that of step SB-1 in the image reading processing (1) shown in FIG. 5 and the explanation thereof is thus omitted.

The light amount change rate calculating unit 302c calculates the light amount change rate for each reading target line with the object-image distance L. The correction value calculating unit 302d calculates the parameter correction value of a light amount based on the light amount change rate calculated by the light amount change rate calculating unit 302c. The light amount adjusting unit 302b prepares correction information based on the parameter correction value calculated by the correction value calculating unit 302d, sets a value of exposed time of the imaging unit 22 for each line based on the correction information, and controls and adjusts the exposed time of the imaging unit 22 so as to keep the luminance of the surface of the medium S to be read constant (step SC-2). The light amount adjusting unit 302b may adjust a light amount so as to keep the luminance on the surface of the medium S to be read constant based on the variation of the height acquired by the variation acquiring unit 302a. The light amount adjusting unit 302b may calculate the value of exposed time corresponding to each reading target line before the imaging unit 22 reads images and prepare a table that represents the reading target lines and the values of the exposed time for the reading target lines so as to correspond to each other.

An example of the table that represents the reading target lines and the values of exposed time for the reading target lines so as to correspond to each other in the embodiment is explained below with reference to FIG. 10. FIG. 10 is a diagram of an example of the table that represents the reading target lines and the values of exposed time for the reading target lines so as to correspond to each other.

As illustrated in FIG. 10, in the table that represents the reading target lines and the values of exposed time for the reading target lines, the reading target lines (1, 2, 3, . . . , and α) based on the number of reading target lines α of the medium S to be read calculated by the variation acquiring unit 302a and values of exposed time (001, 002, 003, . . . , and 999) are stored so as to correspond to each other. Preparation of such a table in advance enables light amount change rate calculation and image reading to be separately performed and processing to be performed at high speed when reading of the medium S to be read of the same type is repeated, for example.

The processing from step SC-3 to step SC-5 in the image reading processing (2) shown in FIG. 9 is the same as that from step SB-3 to SB-5 in the image reading processing (1) shown in FIG. 5 and the explanation thereof is thus omitted.

### Other Embodiment

The embodiment of the present invention is explained above. However, the present invention may be implemented in various different embodiments other than the embodiment described above within a technical scope described in claims.

For example, an example in which the overhead image-reading apparatus 1 performs the processing as a standalone apparatus is explained. However, the overhead image-reading apparatus 1 can connect to an external device such as PC via network, and be configured to perform processes in response to request from the external device that includes software (computer program, data, or the like) to carry out the method of the present invention and return the process results including produced image data to the external device.

All the automatic processes explained in the present embodiment can be, entirely or partially, carried out manually. Similarly, all the manual processes explained in the present embodiment can be, entirely or partially, carried out automatically by a known method.

The process procedures, the control procedures, specific names, information including registration data for each process and various parameters such as search conditions, display example, and database construction, mentioned in the description and drawings can be changed as required unless otherwise specified.

The constituent elements of the overhead image-reading apparatus 1 are merely conceptual and may not necessarily physically resemble the structures shown in the drawings.

For example, the process functions performed by each device of the overhead image-reading apparatus 1, especially the each process function performed by the controlling unit 302, can be entirely or partially realized by CPU and a computer program executed by the CPU or by a hardware using wired logic. The computer program, recorded on a non-transitory computer readable recording medium including programmed commands for causing a computer to execute the method of the present invention, can be mechanically read by the overhead image-reading apparatus 1 as the situation demands. In other words, the storage unit 306 such as read-only memory (ROM) or hard disk drive (HDD) stores the computer program that can work in coordination with an operating system (OS) to issue commands to the CPU and cause the CPU to perform various processes. The computer program is first loaded to the random access memory (RAM), and forms the control unit in collaboration with the CPU.

Alternatively, the computer program can be stored in any application program server connected to the overhead image-reading apparatus 1 via the network, and can be fully or partially loaded as the situation demands.

The computer program may be stored in a computer-readable recording medium, or may be structured as a program product. Here, the “recording medium” includes any “portable physical medium” such as a memory card, a USB (Universal Serial Bus) memory, an SD (Secure Digital) card, a flexible disk, an optical disk, a ROM, an EPROM (Erasable Programmable Read Only Memory), an EEPROM (Electronically Erasable and Programmable Read Only Memory), a CD-ROM (Compact Disk Read Only Memory), an MO (Magneto-Optical disk), a DVD (Digital Versatile Disk), and a Blu-ray Disc.

Computer program refers to a data processing method written in any computer language and written method, and can have software codes and binary codes in any format. The computer program can be a dispersed form in the form of a plurality of modules or libraries, or can perform various functions in collaboration with a different program such as the OS. Any known configuration in the each device according to the embodiment can be used for reading the recording medium. Similarly, any known process procedure for reading or installing the computer program can be used.

Various databases stored in the storage unit 306 is a storage unit such as a memory device such as a RAM or a ROM, a fixed disk device such as a HDD, a flexible disk, and an optical disk, and stores therein various programs, tables, databases, and web page files used for providing various processing or web sites.

The distribution and integration of the device are not limited to those illustrated in the figures. The device as a whole or in parts can be functionally or physically distributed or integrated in an arbitrary unit according to various attachments or how the device is to be used. That is, any embodiments described above can be combined when implemented, or the embodiments can selectively be implemented.

According to the present invention, the occurrence of contrast variation in images due to a change in a light amount on a document surface caused by a change in the object-image distance can be suppressed.

According to the present invention, a light amount can be adjusted so as to keep a light amount on the document surface constant.

According to the present invention, images having no contrast variation can be acquired even when the luminance of the light source cannot be changed.

According to the present invention, a light amount can be changed based on a result of calculating light amount information for each object-image distance.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An overhead image-reading apparatus comprising:
an imaging unit integrally formed with a light source; and
a light amount adjusting unit that adjusts a light amount so as to keep luminance of a surface of a medium to be read constant based on a correction value of the light amount corresponding to an object-image distance.

2. The overhead image-reading apparatus according to claim 1, wherein
the light amount adjusting unit adjusts the light amount by controlling luminance of the light source.

3. The overhead image-reading apparatus according to claim 1, wherein
the light amount adjusting unit adjusts the light amount by controlling exposed time of the imaging unit.

4. The overhead image-reading apparatus according to claim 1, wherein
the light amount adjusting unit further includes:
a light amount change rate calculating unit that calculates a light amount change rate for each line with the object-image distance, and
a correction value calculating unit that calculates the correction value of the light amount based on the light amount change rate.

5. An image processing method executed by an overhead image-reading apparatus including an imaging unit integrally formed with a light source,
the method executed by the overhead image-reading apparatus comprising:
a light amount adjusting step of adjusting a light amount so as to keep luminance of a surface of a medium to be read constant based on a correction value of the light amount corresponding to an object-image distance.

6. A computer program product having a non-transitory computer readable mediums including programmed instructions for an image processing method executed by an overhead image-reading apparatus including an imaging unit integrally formed with a light source, wherein
the instructions, when executed by the overhead image-reading apparatus, cause the overhead image-reading apparatus to execute:
a light amount adjusting step of adjusting a light amount so as to keep luminance of a surface of a medium to be read constant based on a correction value of the light amount corresponding to an object-image distance.
